(19) United States
(12) Patent Application Publication
(10) Pub. No.: US 2018/0352320 A1
(43) Pub. Date: Dec. 6, 2018

(54) SPORTS TOUCH-CONTROL BLUETOOTH EARPHONE

(71) Applicant: Kingstate Electronics (Dongguan) Co.,Ltd, Dong Guan City (CN)

(72) Inventors: Shun-Peng LIN, Dong Guan City (CN); Szu-Ming YIN, Dong Guan City (CN); Ting-Wei LEE, Dong Guan City (CN); Yi-Jen CHANG, Dong Guan City (CN)

(21) Appl. No.: 15/866,264

(22) Filed: Jan. 9, 2018

(30) Foreign Application Priority Data
Jun. 6, 2017 (CN) 201710418631.9

(51) Int. Cl. H04R 1/10; G06F 3/0354

(52) U.S. Cl. CPC H04R 1/1041; H04R 1/1016; H04R 2420/07; G06F 3/03547; H04R 1/1066

(57) ABSTRACT

A small sports touch-control Bluetooth earphone includes a neckband, cases, earplug sets and a Bluetooth touch-control device. The Bluetooth touch-control device includes an MCU, a Bluetooth IC module, a touch-control IC module, a receiver module and a capacitive touchpad. The mechanical keys on the traditional Bluetooth earphone are replaced by the capacitive touchpad. The user can control by touching the case with fingers, thereby performing various functions in a convenient way. The capacitive touchpad is disposed inside the case, forming a sealed structure. The sealing effect is sufficiently good to effectively separate external liquids and objects, thereby achieving waterproof and dustproof effects.

### FIELD OF THE INVENTION

The invention relates to earphones and, in particular, to a sports touch-control Bluetooth earphone and the working principles thereof.

### BACKGROUND OF THE INVENTION

With the continuous improvement of living standards, work pressure also increases. Bluetooth earphones have provided convenience to people in business, entertainment, travel, and exercises. Bluetooth earphones takes the advantage of the Bluetooth technology on hands-free earphones. Users can get away with annoying cables, and enjoy relaxed and easy phone calls or music. Since the advent of Bluetooth earphones, they have been serving people in mobile business, entertainment, evening jogs, and tourists.

However, current Bluetooth earphones are all designed with the structure of mechanical keys. When the user commutes, jogs, rides a bicycle, or travels, the earphone may encounter rain, heavy sweat or other liquids. Such liquids can enter the case via the gaps of the mechanical keys or switches, causing damages to the circuit.

### SUMMARY OF THE INVENTION

In view of the foregoing, an objective of the invention is to provide a sports touch-control Bluetooth earphone with an ingenious structural design and the touch-control function. It is easy to use, waterproof, small-sized and portable.

To achieve the above-mentioned objective, the disclosed sports touch-control Bluetooth earphone includes a neckband, cases on both ends of the neckband, an earplug set on each of the cases, a Bluetooth touch-control device disposed in one of the cases, and a battery disposed in the other case. The battery is connected to the Bluetooth touch-control device via the neckband. The Bluetooth touch-control device includes an MCU, a Bluetooth IC module, a touch-control IC module, a receiver module, and a capacitive touchpad. The MCU is connected with the Bluetooth IC module and the touch-control IC module. The receiver module is connected with the Bluetooth IC module. The capacitive touchpad is connected with the touch-control IC module. One of the cases is provided with a touch part, and the position of the touch-control IC module corresponding to the touch part is tightly attached to the inner wall of the case. The capacitive touchpad includes a touch-control substrate and a plurality of metal plates evenly spaced at the central position of the touch-control substrate. The periphery of the touch-control substrate is provided with a ground plate extended along the profile line thereof.

In an embodiment of the invention, the touch-control IC module is a touch-control chip of module FT3267.

In an embodiment of the invention, the receiver module is a MEMS microphone.

In an embodiment of the invention, the touch-control substrate has a circular profile, each of the metal plates has a sector profile, and four of the metal plates are disposed on the touch-control substrate in a symmetric way with respect to the center thereof.

In an embodiment of the invention, each of the cases includes a front cover and a corresponding rear cover, the rear cover has a hook, and the corresponding front cover is provided with an engaging slot for the hook.

In an embodiment of the invention, the inner wall of the rear cover is recessed inwardly to form a recess for accommodate the touch-control substrate.

In an embodiment of the invention, the earplug set includes an ear cavity case, a horn silicone shell, a speaker and a silicone earplug; the ear cavity case is arranged on the outer wall of the front cover, the speaker is disposed in the ear cavity case, the silicon earplug is arranged on the front end of the ear cavity case, and the horn silicone shell is mounted on the ear cavity case.

In an embodiment of the invention, the thickness of the touch part is smaller than or equal to 0.5 mm.

In an embodiment of the invention, the Bluetooth touch-control device further includes a main substrate. The upper portion of one surface of the main substrate is arranged with display light-emitting diodes (LEDs), a power switch and an antenna. The lower portion thereof is arranged with a micro USB port, an FPC socket, the Bluetooth IC module and the MCU. One of the cases has a display window, a connection window, and a switch window for exposing respectively the LEDs, the micro USB port, and the power switch. The display window has a sealing transparent cover, the connection window has a sealing soft cover, and the switch window has a sealing power button. The other surface of the main substrate is provided with the receiver module.

In an embodiment of the invention, the touch-control substrate is a FPC board whose one side extends outward to form a connection terminal, and the connection terminal is provided with an FPC plug that matches with the FPC socket.

The beneficial effects of the invention are as follows: the disclosed structure of is reasonably designed to replace the physical mechanical keys or switches on the conventional Bluetooth earphone with the capacitive touchpad. The user can perform various functions such as play, pause, the next song and the previous song by touching the case. The operation is simple and convenient. Since the capacitive touchpad is disposed inside the case, in a fully enclosed structure with a good sealing effect. It can effectively prevent external liquids and objects from entering, achieving good waterproof and dustproof effects. Therefore, the lifetime of the earphone can be effectively extended. Besides, the overall structure of the invention has a compact size, a light weight, and a beautiful appearance. It is easy to carry and use, bringing convenience to daily work and life.

### BRIEF DESCRIPTION OF THE DRAWINGS

FIG. 1 shows the circuit of the invention;

FIG. 2 schematically shows the structure of the capacitive touchpad in the invention;

FIG. 3 is a schematic three-dimensional view of the invention;

FIG. 4 is an exploded view of the invention;

FIG. 5 is a schematic view of the Bluetooth touch-control device in the invention;

FIG. 6 is a side view of the Bluetooth touch-control device in the invention; and

FIG. 7 is a schematic view of the FPC plug in the invention.

### DESCRIPTION OF THE PREFERRED EMBODIMENTS

The aforementioned and other objectives and advantages of this disclosure will become clearer in light of the following detailed description of an illustrative embodiment of this invention described in connection with the drawings.

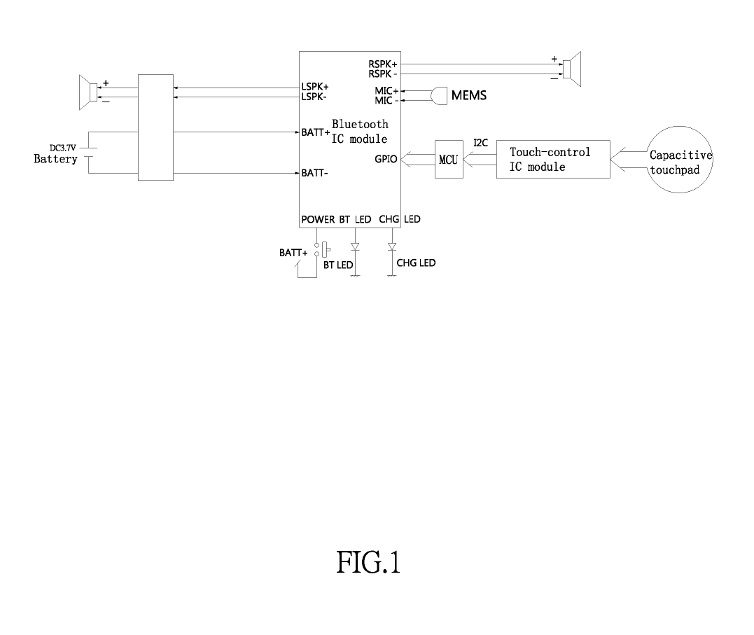

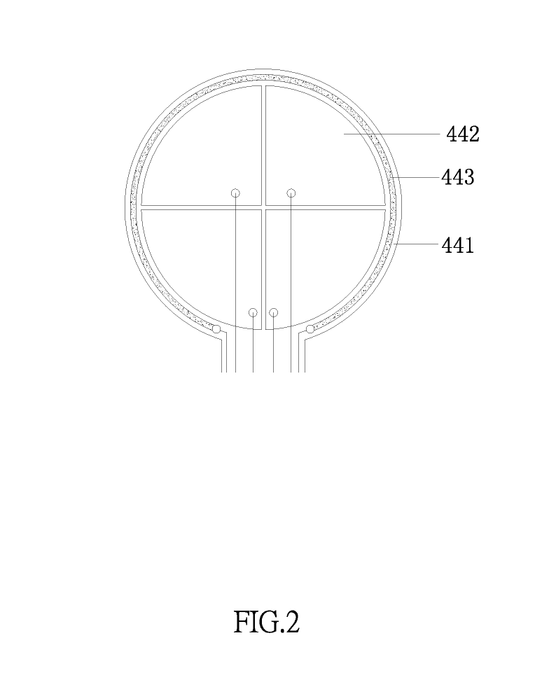

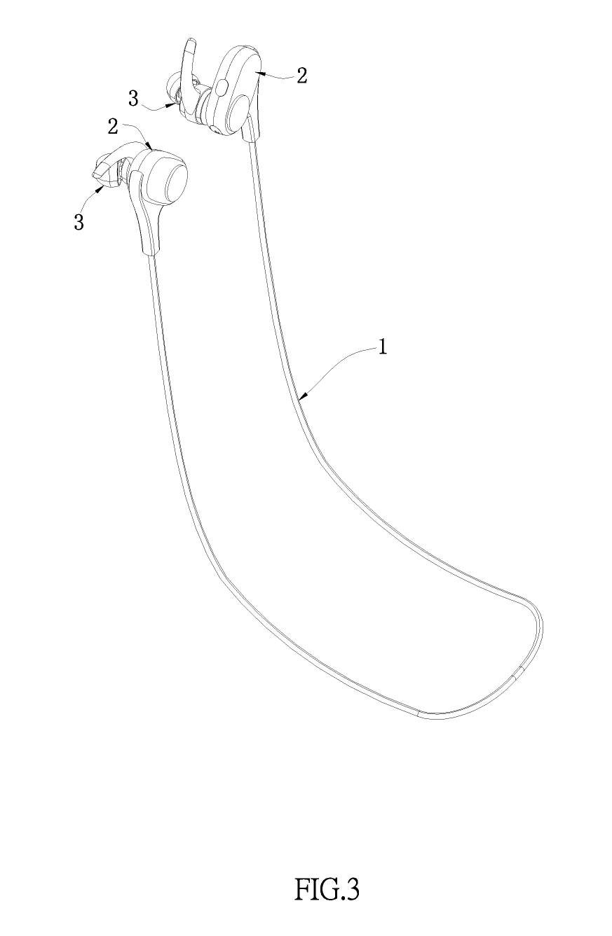

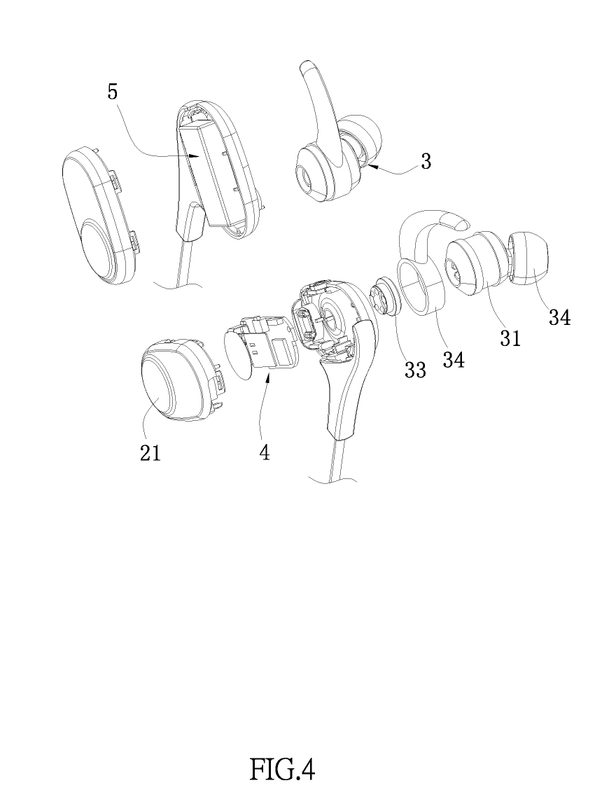

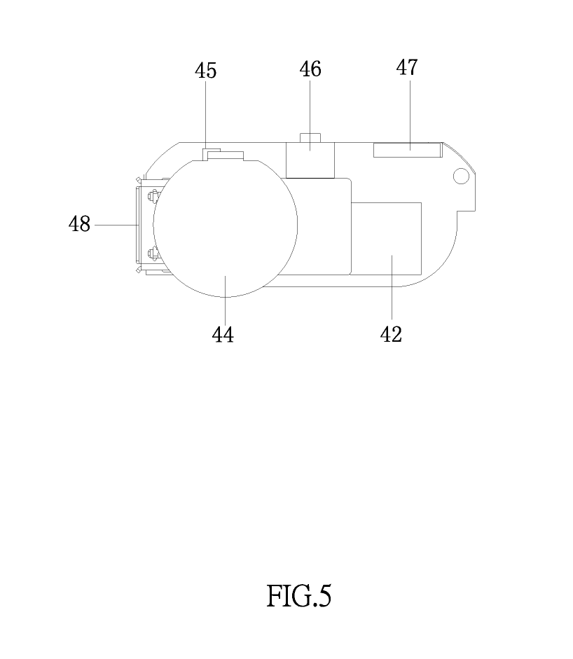

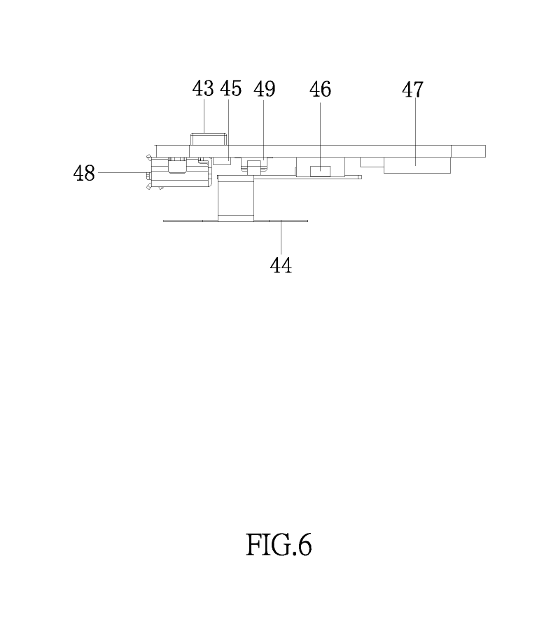

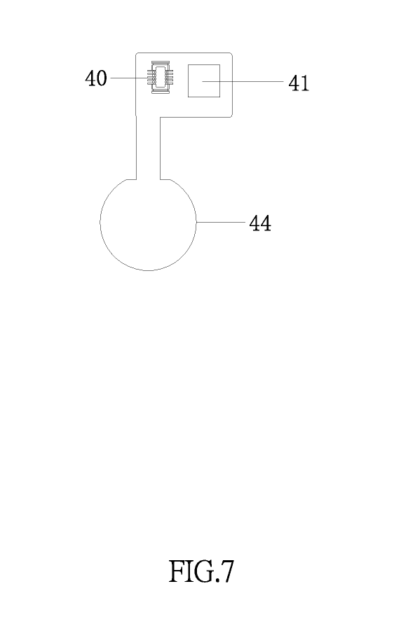

With reference to FIGS. 1 to 7, the disclosed sports touch-control Bluetooth earphone includes a neckband 1, cases 2 on both ends of the neckband 1, an earplug set 3 on each of the cases 2, a Bluetooth touch-control device 4 disposed in one of the cases 2 and a battery 5 disposed in the other case 2. The battery 5 is connected to the Bluetooth touch-control device 4 via the neckband 1. The Bluetooth touch-control device 4 includes an MCU, a Bluetooth IC module 41, a touch-control IC module 42, a receiver module 43, and a capacitive touchpad 44. The MCU is connected with the Bluetooth IC module 41 and the touch-control IC module 42. The receiver module 43 is connected with the Bluetooth IC module 41. The capacitive touchpad 44 is connected with the touch-control IC module 42. One of the cases 2 is provided with a touch part 21, and the position of the touch-control IC module 42 corresponding to the touch part 21 is tightly attached to the inner wall of the case 2. The thickness of the touch part 21 is preferred to be smaller than or equal to 0.5 mm to effectively ensure the stability and sensitivity of the touch control.

The capacitive touchpad 44 includes a touch-control substrate 441 and a plurality of metal plates 442 evenly spaced at the central position of the touch-control substrate 441. The periphery of the touch-control substrate 441 is provided with a ground plate 443 extended along the profile line thereof. That is, the ground plate 443 encloses the periphery of the touch-control substrate 441 to effectively prevent external noises, greatly increasing the accuracy in touch control.

In this embodiment, the touch-control substrate 441 has a circular profile. The metal plate 442 has a sector profile. Four of the metal plates 442 are disposed on the touch-control substrate 441 in a symmetric way with respect to the center. As a whole, a circular metal plate 442 is formed with a cross-shaped gap. The diameter of the circular metal plate 442 is greater than or equal to 5 mm to effective reduce errors in touch control. In another embodiment, the touch-control substrate 441 has a profile in accord with the shape of the case, such as an ellipse or square.

In this embodiment, the touch-control IC module 42 is a touch-control chip of the model FT3267. The receiver module 43 is a MEMS microphone, and is close to the user's mouth to get a better voice-taking effect. Moreover, it is minimized in volume to save space. Preferably, the micro USB port uses the popular structure so that the user can use the usual charging equipment, such as mobile phone chargers and portable chargers. In some other embodiment, the micro USB can be replaced by a port of another specification, such as USB type-c.

More explicitly, each of the cases 2 includes a front cover and a corresponding rear cover, the rear cover having a hook and the corresponding front cover being provided with an engaging slot for the hook. The inner wall of the rear cover is recessed inwardly to form a recess for accommodating the touch-control substrate 441.

The earplug set 3 includes an ear cavity case 31, a horn silicone shell 32, a speaker 33 and a silicone earplug 34. The ear cavity case 31 is arranged on the outer wall of the front cover. The speaker 33 is disposed in the ear cavity case 31. The silicon earplug 34 is arranged on the front end of the ear cavity case 31, and the horn silicone shell 32 is mounted on the ear cavity case 31.

In a preferred embodiment, the Bluetooth touch-control device 4 in the disclosed sports touch-control Bluetooth earphone further includes a main substrate. On one surface of the main substrate, the upper portion is arranged with display LEDs 45, a power switch 46 and an antenna 47. The lower portion thereof is arranged with a micro USB port 48, an FPC socket 49, the Bluetooth IC module 41 and the MCU. One of the cases 2 has a display window, a connection window, and a switch window for exposing respectively the LEDs 45, the micro USB port 48, and the power switch 46. The display window has a sealing transparent cover, the connection window has a sealing soft cover, and the switch window has a sealing power button. The touch-control substrate 441 is preferably an FPC board. One side of the FPC board extends outward to form a connection terminal, which is provided with an FPC plug 40 that matches with the FPC socket 49 thereon. The other surface of the main substrate is provided with the receiver module 43. Such a structure is ingenious, reasonable, and compact. It greatly simplifies the overall structure to minimize its size, so that the earphone is small and portable. Preferably, a power switch 46 is used for power on, power off, and Bluetooth pairing. The power of the Bluetooth earphone can be completely turned off to save energy.

After pairing, the user can follow the procedure provided by the MCU to set various parameters, such as touch-control sensitivity, effective touch-control time, invalid touch-control time, sleep time, deep sleep time, abnormal time, and other operation modes.

For example, in the music playing mode, one short press means to play or pause. Two short presses mean to play the next song. Three short presses mean to play the previous song.

In the incoming call mode, one short press means to receive the incoming call and a long press over one second means to reject the call.

In the conversation mode, one short press means to hang up.

As the user touches, the metal plates 442 detect a minute charge change on the human body. Such a minute charge change is input to the touch-control IC module 42 and converted into I2C data that is sent to MCU. The I2C data is tested and converted into GPIO data and sent to the touch-control IC module 42 for the corresponding control, such as playing, pausing, playing the next song, and playing the previous song. The invention can implement various functions through simple and convenient operations. As the capacitive touchpad 44 is disposed inside the case 2 in a completely sealed structure, the sealing effect is very good. It can effectively prevent external liquids and objects from entering the structure, achieving good waterproof and dustproof effects. Such a structure ensures a longer lifetime of the earphone.

While the invention is described in some detail hereinbelow with reference to certain illustrated embodiments, it is to be understood that there is no intent to limit it to those embodiments. On the contrary, the aim is to cover all modifications, alternatives and equivalents falling within the spirit and scope of the invention as defined by the appended claims.

What is claimed is:

1. A sports touch-control Bluetooth earphone, comprising: a neckband, cases on both ends of the neckband, an earplug set on each of the two cases, a Bluetooth touch-control device in one of the cases, and a battery in the other case; wherein the battery is connected to the Bluetooth touch-control device via the neckband, the Bluetooth touch-control device includes an MCU, a Bluetooth IC module, a touch-control IC module, a receiver module, and a capacitive touchpad; the MCU is connected with the Bluetooth IC module and the touch-control IC module; the receiver module is connected with the Bluetooth IC module; the capacitive touchpad is connected with the touch-control IC module; one of the cases is provided with a touch part; the position of the touch-control IC module corresponding to the touch part is tightly attached to the inner wall of the case; the capacitive touchpad includes a touch-control substrate and a plurality of metal plates evenly spaced at the central position of the touch-control substrate; and the periphery of the touch-control substrate is provided with a ground plate extended along the profile line thereof.

2. The sports touch-control Bluetooth earphone of claim 1, wherein the touch-control IC module is a touch-control chip of model FT3267.

3. The sports touch-control Bluetooth earphone of claim 1, wherein the receiver module is a MEMS microphone.

4. The sports touch-control Bluetooth earphone of claim 1, wherein the touch-control substrate has a circular profile, each of the metal plates has a sector profile, and four of the metal plates are disposed on the touch-control substrate in a symmetric way with respect to the center thereof.

5. The sports touch-control Bluetooth earphone of claim 1, wherein each of the cases includes a front cover and a corresponding rear cover, the rear cover has a hook, and the corresponding front cover is provided with an engaging slot for the hook.

6. The sports touch-control Bluetooth earphone of claim 5, wherein the inner wall of the rear cover is recessed inwardly to form a recess for accommodate the touch-control substrate.

7. The sports touch-control Bluetooth earphone of claim 6, wherein the earplug set includes an ear cavity case, a horn silicone shell, a speaker and a silicone earplug; the ear cavity case is arranged on the outer wall of the front cover, the speaker is disposed in the ear cavity case, the silicon earplug is arranged on the front end of the ear cavity case, and the horn silicone shell is mounted on the ear cavity case.

8. The sports touch-control Bluetooth earphone of claim 1, wherein the thickness of the touch part is smaller than or equal to 0.5 mm.

9. The sports touch-control Bluetooth earphone of claim 1, wherein the Bluetooth touch-control device further includes a main substrate; the upper portion of one surface of the main substrate is arranged with light-emitting diodes (LEDs), a power switch and an antenna; the lower portion thereof is arranged with a micro USB port, an FPC socket, the Bluetooth IC module and the MCU; one of the cases has a display window, a connection window, and a switch window for exposing respectively the LEDs, the micro USB port, and the power switch; the display window has a sealing transparent cover, the connection window has a sealing soft cover, and the switch window has a sealing power button; and the other surface of the main substrate is provided with the receiver module.

10. The sports touch-control Bluetooth earphone of claim 9, wherein the touch-control substrate is a FPC board whose one side extends outward to form a connection terminal, and the connection terminal is provided with an FPC plug that matches with the FPC socket.
